(19) United States
(12) Patent Application Publication
(10) Pub. No.: US 2004/0103926 A1
(43) Pub. Date: Jun. 3, 2004

(54) Dishwasher

(75) Inventor: Jae Hoon Ha, Jinhae-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/721,176

(22) Filed: Nov. 26, 2003

(30) Foreign Application Priority Data
Nov. 28, 2002 (KR) P2002-75065

(51) Int. Cl. B08B 3/00

(52) U.S. Cl. 134/57 D; 134/58 D

(57) ABSTRACT

Disclosed is a dishwasher, in which amounts of water supplied to top and bottom nozzles can be controlled by a simply configured valve assembly. The present invention includes a washing chamber, top and bottom nozzles injecting water in the washing chamber, a sump provided under the washing chamber to store the water, a pump pumping the water stored in the sump, a supply pipe adjacent to one side of the pump wherein the water pumped by the pump flows in the supply pipe, upper and lower pipes connected to the supply pipe to lead the water to the top and bottom nozzles, respectively, a valve rotatably installed at a connecting portion between the supply pipe and the upper and lower pipes to selectively open/close the supply pipe and the upper and lower pipes, and a driving means for turning the valve by checking a position of the valve.

This application claims the benefit of Korean Application(s) No. 10-2002-0075065 filed on Nov. 28, 2003, which is/are hereby incorporated by reference.

### BACKGROUND OF THE INVENTION

1. Field of the Invention

The present invention relates to a dishwasher.

2. Discussion of the Related Art

Generally, a dishwasher is an apparatus for automatically washing and drying tableware by injecting water and detergent on the tableware. A dishwasher according to a related art is explained by referring to the attached drawings.

FIG. 1 is a cross-sectional view of a dishwasher according to a related art.

Referring to FIG. 1, a dishwasher according to a related art mainly consists of a cabinet 2 having a large open front side, a washing chamber 4 provided in the cabinet 2, and a door 6 opening closing the open front side of the cabinet 2.

Upper and lower racks 8 and 9 on which tableware is put are provided in the washing chamber 4, and top and bottom nozzles 12 and 14 injecting water via injection holes 10 are rotatably provided under the upper and lower racks 8 and 9, respectively.

A sump 16 is provided under the washing chamber 4 to collect water therein. A pump 24 connected to a supply pipe 22 is provided at one side of the sump 16 to pump water to the top and bottom nozzles 12 and 14. And, a heater assembly (not shown in the drawing) for heating water held in the sump 16 is provided in the sump 16.

The supply pipe 22 is connected to upper and lower pipes 26 and 28 guiding water to the top and bottom nozzles 12 and 14, respectively. Hence, when the pump 24 operates, the water in the sump 16 is supplied to the top and bottom nozzles 12 and 14 via the supply pipe 22 and the upper and lower pipes 26 and 28. Inlet valve and pipe for supplying water to the sump 16 and drain pump assembly and pipe for draining the water in the sump are installed at one side of the sump 16.

And, a filter 18 is installed over the sump 16 to filter the water flowing in the sump 16 from the washing chamber 4 to remove particles from the water.

Meanwhile, a valve assembly 30 for electrically opening/closing the upper and lower pipes 26 and 28 is installed at a portion where the upper and lower pipes 26 and 28 are connected to the supply pipe 22 to selectively allow the water flow in.

FIG. 2 is a cross-sectional view of a valve assembly of a dishwasher according to a related art.

Referring to FIG. 2, the valve assembly 30 consists of protrusions 32a and 32b formed inside the upper and lower pipes 26 and 28, respectively, a pair of check valves 34a and 34b, and a par of solenoid valves 36a and 36b.

The check valves 34a and 34b are movably installed in the upper and lower pipes 26 and 28 to open/close the upper and lower pipes 26 and 28, respectively. And, the solenoid valves 36a and 36b are installed under the check valves 34a and 34b to turn on/off the check valves 34a and 34b by magnetic forces, respectively.

Of course, the check valves 34a and 34b are magnetic bodies movable by the magnetic forces on operating the solenoid valves 36a and 36b, respectively.

An operation of the related art dishwasher is explained in short as follows.

First of all, once the pump 24 is driven, the check valves 34a and 34b are moved upward by the water flowing in via the supply pipe 22 to be brought contact with the protrusions 32a and 32b, respectively. Hence, the check valves 34a and 34b blocks the upper and lower pipes 26 and 28 to prevent the water from flowing in the upper and lower pipes 26 and 28, respectively.

Thereafter, once a pair of the solenoid valves 6a and 36b are driven, the check valves 34a and 34b move downward by the magnetic forces to open the upper and lower pipes 26 and 28, respectively. Hence, the water is supplied to the top and bottom nozzles 12 and 14 via the upper and lower pipes 26 and 28, respectively.

Yet, when both of the upper and lower pipes 26 and 28 are open by driving a pair of the solenoid valves 36a and 36b simultaneously, the water is supplied to the top and bottom nozzles 12 and 14 along the upper and lower pipes 26 and 28, respectively so that the water pressures and injection powers thereof are lowered. Hence, the solenoid valves 36a and 36b are selectively operated to supply the water via either the upper or lower pipe 26 or 28.

However, in the related art dishwasher, the magnetic check valves are provided in the upper and lower pipes and the check valves are turned on/off by the expensive solenoid valves, respectively, whereby product costs are increased.

Moreover, since the solenoid valves are electrically driven, electric safety accident may take place as well as power consumption thereof increases.

### SUMMARY OF THE INVENTION

Accordingly, the present invention is directed to a dishwasher that substantially obviates one or more of the problems due to limitations and disadvantages of the related art.

An object of the present invention, which has been devised to solve the foregoing problem, lies in providing a dishwasher, in which amounts of water supplied to top and bottom nozzles can be controlled by a simply configured valve assembly.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a dishwasher including a washing chamber, top and bottom nozzles injecting water in the washing chamber, a sump provided under the washing chamber to store the water, a pump pumping the water stored in the sump, a supply pipe adjacent to one side of the pump wherein the water pumped by the pump flows in the supply pipe, upper and lower pipes connected to the supply pipe to lead the water to the top and bottom nozzles, respectively, a valve rotatably installed at a connecting portion between the supply pipe and the upper and lower pipes to selectively open/close the supply pipe and the upper and lower pipes, and a driving means for turning the valve by checking a position of the valve.

In this case, the valve has a semi-cylindrical shape so that upper and lower ends are hinge-coupled between the supply pipe and the upper and lower pipes.

And, the driving means includes a motor rotating a rotational shaft connected to the valve, a cam connected to the rotational shaft to rotate together with the valve, the cam having a plurality of sections differing in radius from each other, and a sensing unit brought contact with an outer circumference of the cam to control an operation of the motor. Preferably, the motor is a step motor enabling to adjust a rotational angle.

Moreover, the cam includes a first cam having a first radius and a second cam having a second radius smaller than the first radius.

Meanwhile, the sensing unit includes a button brought contact with the outer circumference of the cam to be compressed or restored and a micro switch turned on or off according to a compression or restoration of the button to control the motor.

In this case, the cam includes a first cam having a first radius to compress the button and a second cam having a second radius smaller than the first radius to restore the compressed button.

Moreover, the micro switch cuts off a power applied to the motor for a predetermined time on being switched ‘on/off’.

Meanwhile, the sensing unit may further include a lever provided between the cam and the button to compress or restore the button by being brought contact with the outer circumference of the cam.

In this case, the cam includes a first cam having a first radius to compress the button and a second cam having a second radius smaller than the first radius to restore the compressed button. And, the micro switch cuts off a power applied to the motor for a predetermined time on being switched ‘on/off’.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a dishwasher according to a related art;

FIG. 2 is a cross-sectional view of a valve assembly of a dishwasher according to a related art;

FIG. 3 is a cross-sectional partial view of a dishwasher according to the present invention;

FIG. 4 is a layout of a valve assembly of a dishwasher according to the present invention; and

FIGS. 5A to 5D are layouts of a valve assembly according to the present invention, in which operational states of the valve assembly are shown.

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

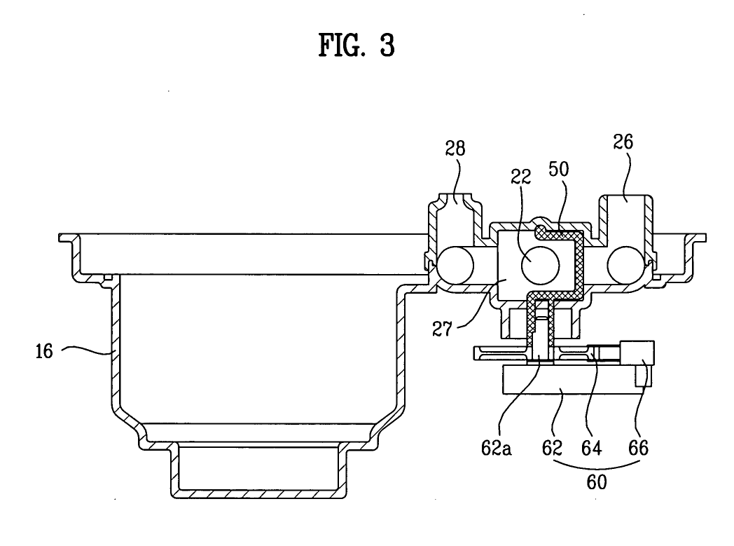

FIG. 3 is a cross-sectional partial view of a dishwasher according to the present invention.

Referring to FIG. 3, a dishwasher according to the present invention includes a sump 16, a supply pipe 22, and upper and lower pipes 26 and 28.

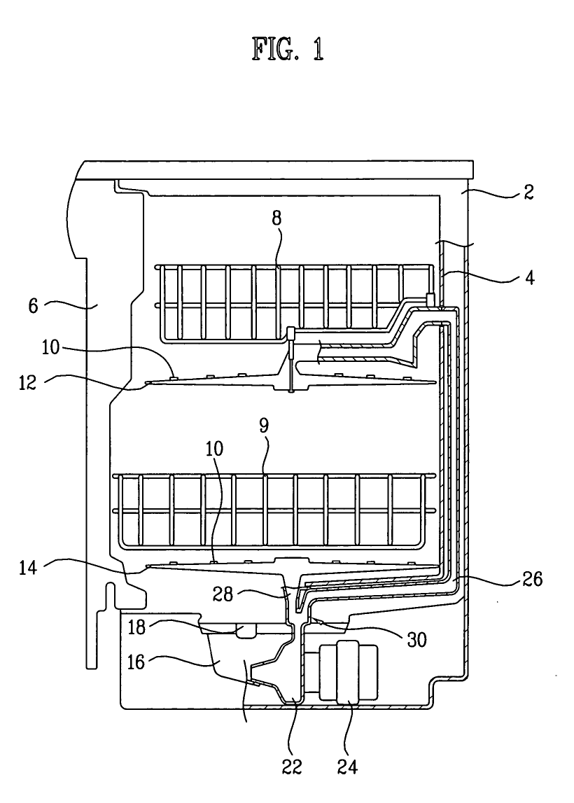

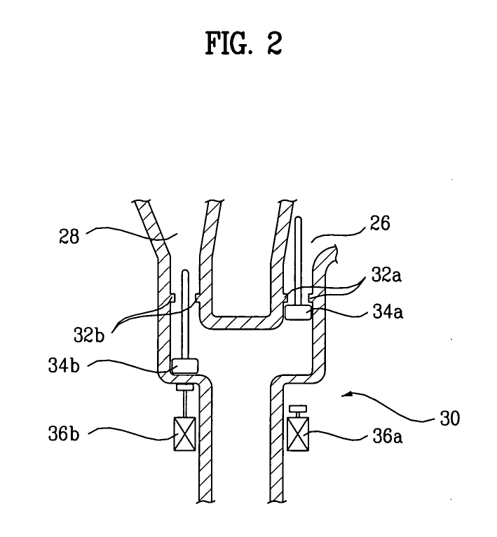

The sump 16 is installed under a washing chamber (cf. ‘4’ in FIG. 1) to store water for washing tableware, and the supply pipe 22 is installed adjacent to one side of a pump (cf. ‘24’ in FIG. 1) to guide the water pumped by the pump.

The upper and lower pipes 26 and 28 are connected to the supply pipe 22 to lead the water to top and bottom nozzles (cf. ‘12’ and ‘14’ in FIG. 1), respectively.

Meanwhile, the dishwasher according to the present invention further includes a valve assembly including a valve 50 and a driving means 60.

The valve 50 is rotatably installed at a connecting portion 27 between the supply pipe 22 and the upper and lower pipes 26 and 28 to selectively open/close the supply pipe 22 and the upper and lower pipes 26 and 28. For this, the valve 50 has a semi-cylindrical shape so that its upper and lower ends are hinge-coupled to the connecting portion 27 between the supply pipe 22 and the upper and lower pipes 26 and 28.

And, the driving means 60 checks a position of the valve 50 to turn the valve 50.

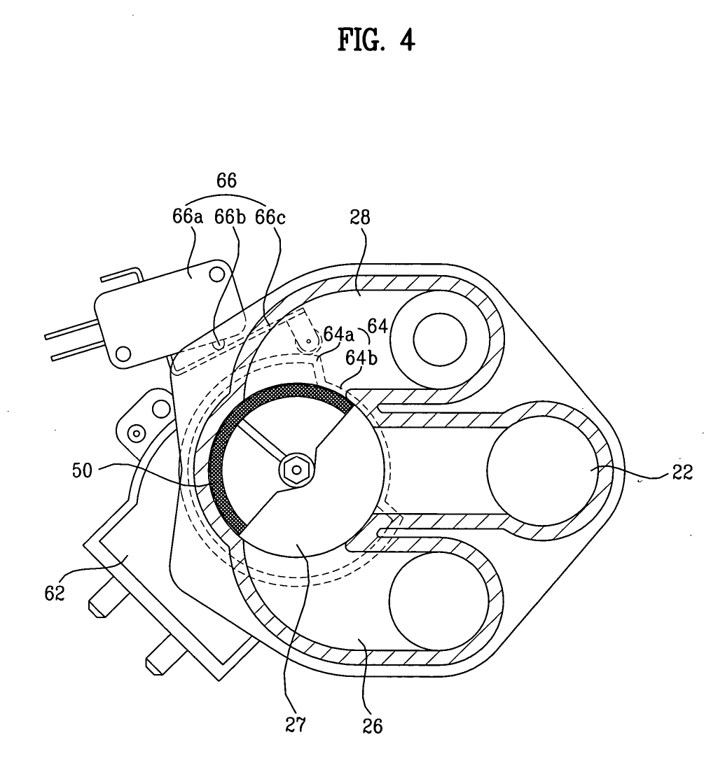

FIG. 4 is a layout of a valve assembly of a dishwasher according to the present invention.

Referring to FIG. 4, the driving means 60 includes a motor 62, a cam 64, and a sensing unit 66. The motor 62 drives a rotational shaft 62a, as shown in FIG. 3, connected to the valve 50 to rotate. And, the cam 64 is connected to the rotational shaft 62a to rotate together with the valve 50, and includes a plurality of sections differing in radius separately.

The sensing unit 66 is provided to be brought contact with an outer circumference of the cam 64 to control an operation of the motor 62.

In this case, the motor 62 is a step motor enabling to adjust a rotational angle, preferably. And, the cam 64 includes a first cam 64a and a second cam 64b having a radius smaller than that of the first cam 64a. Hence, a relatively strong external force is applied to the sensing unit 66 brought contact with the first cam 64a. And, a relatively weak external force is applied to the sensing unit 66 brought contact with the second cam 64b.

Specifically, the sensing unit 66 includes a button 66b brought contact with the outer circumference of the cam 64 to be compressed or restored and a micro switch 66a turned on/off according to compression/restoration of the button 66b to control the motor 62.

In case that the cam 64 includes the first and second cams 64a and 64b, the button 66b is compressed when brought contact with the first cam 64a and is restored when brought contact with the second cam 64b.

And, the micro switch 66a cuts off the power supplied to the motor 62 for a predetermined time on switching on/off. Hence, the motor 62 fails to operate for the predetermined time on switching on/off the micro switch 66a, whereby the valve 50 keeps staying at a predetermined spot as well.

Meanwhile, the sensing unit 66b may further includes a lever 66c provided between the cam 64 and the button 66b to compress or restore the button 66b by being contacted with the outer circumference of the cam 64.

In this case, the lever 66c is configured to be elastically bent or restored according to a contact with the cam 64. Namely, the lever 66c is bent when being contacted with the section of the cam 64 having a large radius but is restored when being contacted with the section of the cam 64 having a small radius.

For instance, in case that the cam 64 includes the first cam 64a and the second cam 64b having a radius smaller than that of the first cam 64a, the lever 66c is bent when being contacted with the first cam 64a but is restored when being contacted with the second cam 64b. Hence, the button 66b is compressed or restored by the lever 66c as well.

An operation of the above-constructed valve assembly according to the present invention is explained as follows.

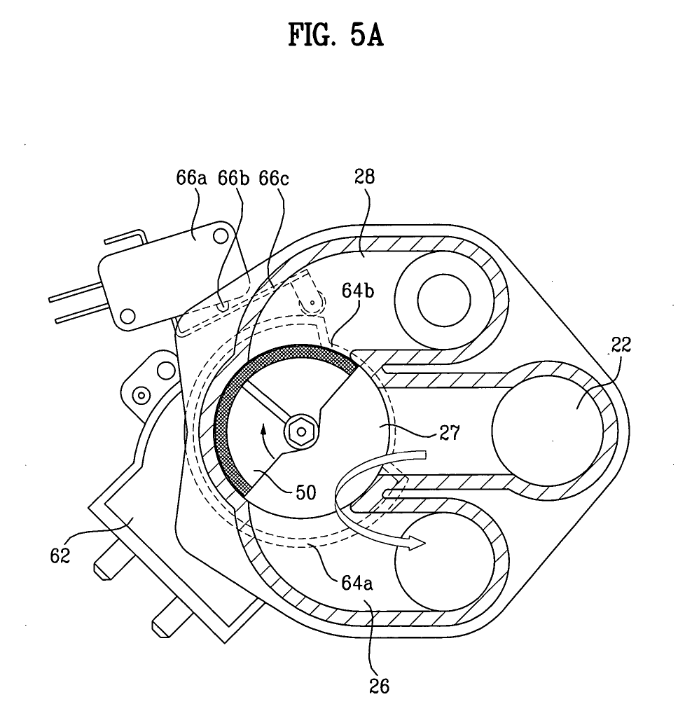

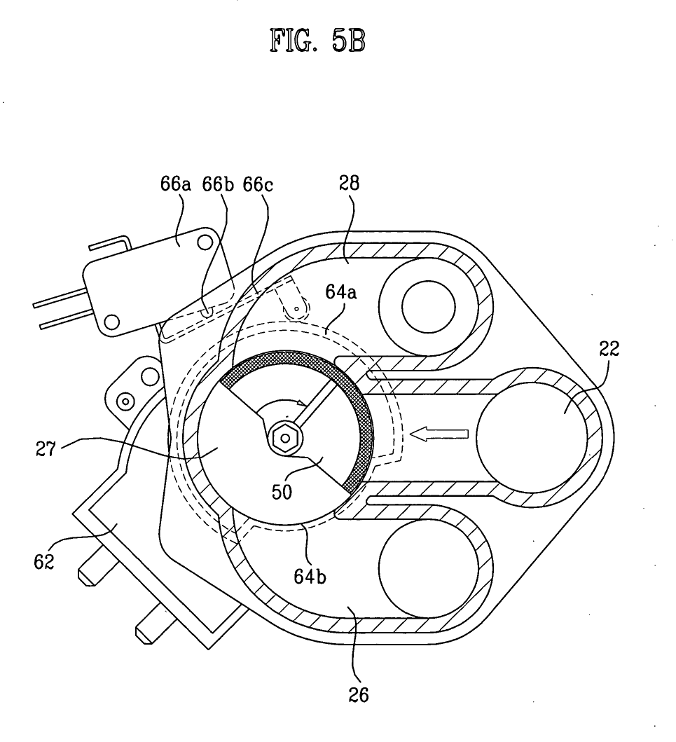

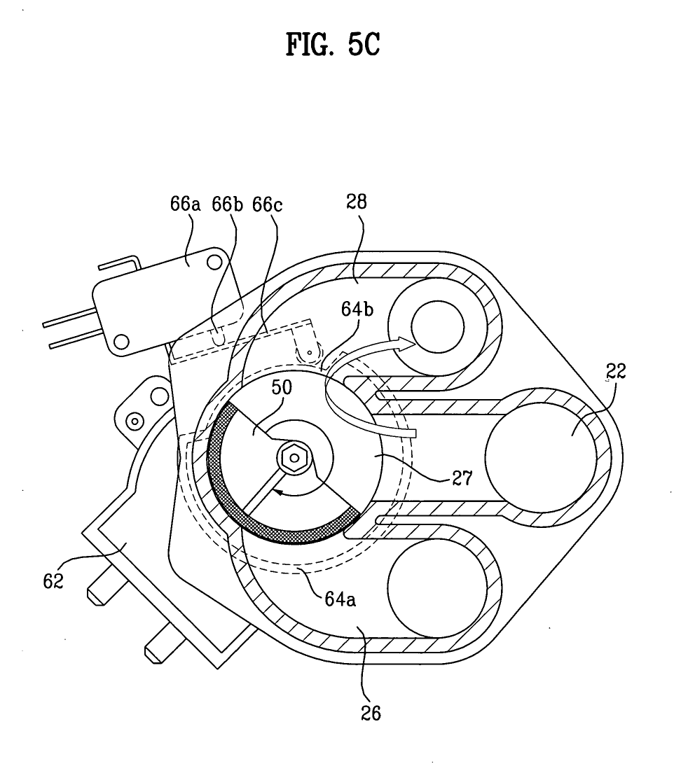

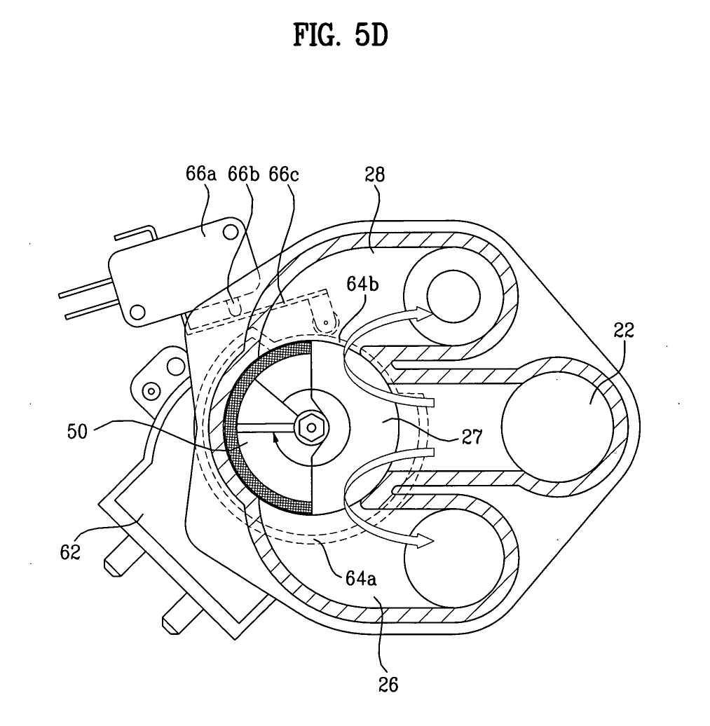

FIGS. 5A to 5D are layouts of a valve assembly according to the present invention, in which operational states of the valve assembly are shown.

Referring to FIG. 5A, when the valve 50 is rotated clockwise by the motor 62 to block the lower pipe 28, the lever 66c is brought contact with the first cam 64a. Hence, the lever 66c is bent by the contact with the first cam 64a to press the button 66b and the micro switch 66a is turned on.

As the valve 50 is located to block the lower pipe 28, the water flowing from the supply pipe 22 is supplied to the top nozzle 12 via the upper pipe 26.

Meanwhile, The micro switch 66a, which is switched to ‘on-state’ from ‘off-state’, cuts off the power applied to the motor 62 for a predetermined time. Hence, the motor 62 stops while the valve 50 blocks the lower pipe 28, whereby the water keeps being supplied to the top nozzle 12 via the upper pipe 26 for the predetermined time.

Referring to FIG. 5B, once the motor 62 operates to turn the valve 50, the valve 50 blocks both of the lower pipe 28 and the supply pipe 22 in a predetermined section.

In this case, the lever 66c keeps being contacted with the first cam 64a. Hence, the button 66b keeps being pressed by the lever 66c and the micro switch 66a keeps being turned on.

And, the water is not supplied to the upper and lower pipes 26 and 28 since the valve 50 blocks the supply pipe 22.

Although not shown in the drawing, if the valve 50 is further turned by the motor 62, the valve 50 blocks both of the supply pipe 22 and the upper pipe 26 in another predetermined section.

In this case, since the lever 66c keeps being contacted with the first cam 64a, the button 66b is pressed and the micro switch 66a keeps being turned on. And, as the valve 50 still blocks the supply pipe 22, the water is not supplied to the upper and lower pipes 26 and 28.

Referring to FIG. 5C, when the valve 50 having undergone the above-explained steps comes into blocking the upper pipe 26 only, the lever 66c is detached from the first cam 64a to return to be contacted with the second cam 64b.

Hence, the button 66b having pressed by the lever 66c is restored and the micro switch 66a is turned off. Moreover, the valve 50 is positioned to block the upper pipe 26 so that the water flowing from the supply pipe 22 is supplied to the lower pipe 28.

In this case, the micro switch 66a, which is switched to ‘off-state’ from ‘on-state’, cuts off the power applied to the motor 62 for a predetermined time. Hence, the motor 62 stops while the valve 50 blocks the upper pipe 62, whereby the water is supplied to the lower nozzle 14 via the lower pipe 28 for the predetermined time.

In doing so, the micro switch 66a is set up to differ in time for cutting off the power supplied to the motor 62 according to a position of the valve 50 each. Thus, the micro switch 66a controls an amount of the water supplied to the upper or lower pipe 26 or 28.

Of course, the micro switch 66a enables to adjust the amount of the water supplied to the upper or lower pipe 26 or 28 by controlling a rotational sped of the motor 62 as well. Namely, the rotational sped of the motor 62 is controlled to adjust the time for the valve 50 to open/close the supply pipe 22 or the upper and lower pipes 26 and 28.

Finally, the valve 50, as shown in FIG. 5D, lies in a position blocking none of the supply pipe 22 and the upper and lower pipes 26 and 28 in a predetermined section. In this case, the lever 66c keeps being contacted with the second cam 64a. Hence, the button 66 keeps being restored and the micro switch 66a keeps being turned off.

As the valve 50 is positioned not to block any of the supply pipe 22 and the upper and lower pipes 26 and 28, the water flowing from the supply pipe 22 is supplied to both of the upper and lower pipes 26 and 28 simultaneously.

Such a procedure is repeated to inject the water in the dishwasher so that the tableware is washed.

Accordingly, the dishwasher according to the present invention has the following advantages or effects.

First of all, the valve, of which position is checked by the sensing unit and which is driven by the motor, enables to selectively open/close the upper and lower pipes and the supply pipe. Therefore, the upper and lower pipes and the supply pipe can be more accurately opened/closed. Moreover, the time for opening/closing the upper and lower pipes and the supply pipe can be adjusted to control the amount of the supplied water.

Secondly, the valve is installed at the connection portion between the upper and lower pipes and the supply pipe. Therefore, the present invention enables to reduce the number of parts thereof as well as the product costs thereof.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A dishwasher comprising:
a washing chamber;
top and bottom nozzles injecting water in the washing chamber;
a sump provided under the washing chamber to store the water;
a pump pumping the water stored in the sump;
a supply pipe adjacent to one side of the pump wherein the water pumped by the pump flows in the supply pipe;
upper and lower pipes connected to the supply pipe to lead the water to the top and bottom nozzles, respectively;
a valve rotatably installed at a connecting portion between the supply pipe and the upper and lower pipes to selectively open/close the supply pipe and the upper and lower pipes; and
a driving means for turning the valve by checking a position of the valve.

2. The dishwasher as claimed in claim 1, wherein the valve has a semi-cylindrical shape so that upper and lower ends are hinge-coupled between the supply pipe and the upper and lower pipes.

3. The dishwasher as claimed in claim 1, the driving means comprising:
a motor rotating a rotational shaft connected to the valve;
a cam connected to the rotational shaft to rotate together with the valve, the cam having a plurality of sections differing in radius from each other; and
a sensing unit brought contact with an outer circumference of the cam to control an operation of the motor.

4. The dishwasher as claimed in claim 3, wherein the motor is a step motor enabling to adjust a rotational angle.

5. The dishwasher as claimed in claim 3, wherein the cam comprises a first cam having a first radius and a second cam having a second radius smaller than the first radius.

6. The dishwasher as claimed in claim 3, the sensing unit comprising:
a button brought contact with the outer circumference of the cam to be compressed or restored; and
a micro switch turned on or off according to a compression or restoration of the button to control the motor.

7. The dishwasher as claimed in claim 6, wherein the cam comprises a first cam having a first radius to compress the button and a second cam having a second radius smaller than the first radius to restore the compressed button.

8. The dishwasher as claimed in claim 6, wherein the micro switch cuts off a power applied to the motor for a predetermined time on being switched ‘on/off’.

9. The dishwasher as claimed in claim 6, the sensing unit further comprising a lever provided between the cam and the button to compress or restore the button by being brought contact with the outer circumference of the cam.

10. The dishwasher as claimed in claim 9, wherein the cam comprises a first cam having a first radius to compress the button and a second cam having a second radius smaller than the first radius to restore the compressed button.

11. The dishwasher as claimed in claim 9, wherein the micro switch cuts off a power applied to the motor for a predetermined time on being switched ‘on/off’.
